(19) United States
(12) Patent Application Publication
(10) Pub. No.: US 2024/0178413 A1
(43) Pub. Date: May 30, 2024

(54) SEPARATOR

(71) Applicants: TAIHO KOGYO CO., LTD., Toyota-shi, Aichi (JP); NIPPON GASKET CO., LTD., Toyota-shi, Aichi (JP)

(72) Inventors: Tatsuya TOKUMASU, Toyota-shi, Aichi (JP); Masahiro KAWAHARA, Toyota-shi, Aichi (JP); Naoya MURAI, Toyota-shi, Aichi (JP); Kenji UCHIDA, Toyota-shi, Aichi (JP); Hiroyuki ARAI, Toyota-shi, Aichi (JP)

(73) Assignees: TAIHO KOGYO CO., LTD., Toyota-shi, Aichi (JP); NIPPON GASKET CO., LTD., Toyota-shi, Aichi (JP)

(21) Appl. No.: 18/552,678

(22) PCT Filed: May 16, 2022
(86) PCT No.: PCT/JP2022/020407

§ 371 Date: Sep. 27, 2023

(30) Foreign Application Priority Data
May 21, 2021 (JP) 2021-086054

(51) Int. Cl. H01M 8/0276; H01M 8/0258

(52) U.S. Cl. CPC H01M 8/0276; H01M 8/0258

(57) ABSTRACT

A separator includes: an anode separator including an anode side surface on which a fuel gas flow passage groove is formed; a cathode separator including a cathode side surface on which an oxidation gas flow passage groove is formed; a joint portion that extends so as to surround the fuel gas flow passage groove and the oxidation gas flow passage groove, and joins the anode separator and the cathode separator to each other; and an outer peripheral seal portion provided on at least one of the fuel gas flow passage groove and the oxidation gas flow passage groove, extending along the joint portion, and formed so as to overlap the joint portion when viewed in a thickness direction of the separator.

### TECHNICAL FIELD

The present invention relates to a technique of a separator constituting a fuel cell.

### BACKGROUND ART

Conventionally, a technique of a separator constituting a fuel cell is known. For example, Patent Literature 1 discloses such a technique.

A separator described in Patent Literature 1 is formed by integrally joining outer peripheral portions of a first separator and a second separator by welding or the like in a state where the first separator and the second separator face each other. The separator and an MEA (electrolyte membrane/electrode structure) are alternately stacked so as to be adjacent to each other, thereby forming a fuel cell.

In the first separator and the second separator, a region surrounded by the joint portion formed by the welding is formed on each facing surface. A cooling medium for cooling the separator is fed to the region surrounded by the joint portion.

Furthermore, in the first separator and the second separator, a seal portion for preventing leakage of fuel gas or oxidation gas fed to the MEA for power generation is formed on an outer peripheral portion of a surface facing a side of the adjacent MEA. In the separator, power generation using the MEA is performed in a region surrounded by the seal portion.

In such a separator, the power generation efficiency and the cooling efficiency of the separator can be improved by relatively increasing an area of the region surrounded by the joint portion or the seal portion. However, it is not desirable to increase an outer shape of the separator itself from the viewpoint of manufacturing cost of the separator, installation space of the fuel cell, and the like. Therefore, there is a demand for a separator that can effectively utilize the area by relatively increasing the area of the region surrounded by the seal portion without increasing the outer shape of the separator itself.

### CITATION LIST

### Patent Literature

Patent Literature 1: JP 2019-186165 A

### SUMMARY OF INVENTION

### Technical Problem

The present invention has been made in view of the above circumstances, and an object of the present invention is to provide a separator capable of effectively utilizing an area.

### Solution to Problem

The problem to be solved by the present invention is as described above, and means for solving the problem will be described below.

That is, the separator of the present invention is a separator that is formed in a plate shape, constitutes a fuel cell, and is disposed so as to be adjacent to an electrolyte membrane to which fuel gas and oxidation gas are fed, the separator including: an anode separator including a fuel gas flow passage surface on which a flow path of the fuel gas is formed; a cathode separator including an oxidation gas flow passage surface on which a flow path of the oxidation gas is formed; a joint portion that extends so as to surround the flow path of the fuel gas and the flow path of the oxidation gas, and joins the anode separator and the cathode separator to each other; and a seal portion provided on at least one of the fuel gas flow passage surface and the oxidation gas flow passage surface, extending along the joint portion, and formed so as to overlap the joint portion when viewed in a thickness direction of the separator.

Furthermore, the seal portion is formed over an entire circumference of the joint portion.

Furthermore, at least a part of the seal portion is formed at a position offset inward with respect to the joint portion overlapping as viewed in the thickness direction.

Furthermore, at least a part of the seal portion is formed at a position offset outward with respect to the joint portion overlapping as viewed in the thickness direction.

Furthermore, the seal portion includes a first portion formed at a position offset inward with respect to the joint portion overlapping as viewed in the thickness direction, and a second portion formed at a position offset outward with respect to the joint portion overlapping as viewed in the thickness direction, the second portion being different from the first portion.

Furthermore, the seal portion is provided on both the fuel gas flow passage surface and the oxidation gas flow passage surface, and the seal portion formed on the fuel gas flow passage surface and the seal portion formed on the oxidation gas flow passage surface are formed at positions offset from each other.

### Advantageous Effects of Invention

As effects of the present invention, the following effects are obtained.

In the separator of the present invention, an area of the separator can be effectively used.

In the separator of the present invention, an area of a portion surrounded by the joint portion can be made relatively large.

In the separator of the present invention, an area of a portion surrounded by the seal portion can be made relatively large.

In the separator of the present invention, an area of a portion surrounded by the joint portion overlapping the first portion can be made relatively large.

In the separator of the present invention, an area of a portion surrounded by one of the seal portion formed on the anode separator and the seal portion formed on the cathode separator can be made relatively large.

### BRIEF DESCRIPTION OF DRAWINGS

FIG. 1 is a perspective view illustrating a fuel cell including a separator according to a first embodiment of the present invention.

FIG. 2 is an exploded perspective view illustrating the separator and a membrane electrode assembly.

FIG. 3 is an exploded perspective view illustrating the separator.

FIG. 4 is a rear view illustrating the separator.

FIG. 5 is a front view illustrating the separator.

FIG. 6(a) is a side cross-sectional view illustrating the separator according to the first embodiment. FIG. 6(b) is a side cross-sectional view illustrating a separator to be compared.

FIG. 7 is a side cross-sectional view illustrating the separator and the membrane electrode assembly.

FIG. 8 is a schematic diagram illustrating a state of power generation using a fuel cell.

FIG. 9(a) is a front view schematically illustrating the separator according to the first embodiment. FIG. 9(b) is a cross-sectional view taken along line B1-B1 in FIG. 9(a).

FIG. 10(a) is a front view schematically illustrating an example of a separator according to a second embodiment of the present invention. FIG. 10(b) is a front view schematically illustrating another example of the separator according to the second embodiment. FIG. 10(c) is a front view schematically illustrating still another example of the separator according to the second embodiment. FIG. 10(d) is a cross-sectional view taken along line B2-B2 in FIG. 10(c).

FIG. 11(a) is a front view schematically illustrating an example of a separator according to a third embodiment of the present invention. FIG. 11(b) is a front view schematically illustrating another example of the separator according to the third embodiment. FIG. 11(c) is a front view schematically illustrating still another example of the separator according to the third embodiment. FIG. 11(d) is a cross-sectional view taken along line B3-B3 in FIG. 11(c).

FIG. 12(a) is a front view schematically illustrating an example of a separator according to a fourth embodiment of the present invention. FIG. 12(b) is a front view schematically illustrating another example of the separator according to the fourth embodiment. FIG. 12(c) is a front view schematically illustrating a separator according to a fifth embodiment of the present invention. FIG. 12(d) is a cross-sectional view taken along line B4-B4 in FIG. 12(c).

FIG. 13 is a side cross-sectional view schematically illustrating a separator and a membrane electrode assembly according to a sixth embodiment of the present invention.

### DESCRIPTION OF EMBODIMENTS

In the following description, directions indicated by arrows U, D, F, B, L, and R in the drawings are defined as an upward direction, a downward direction, a forward direction, a backward direction, a left direction, and a right direction, respectively.

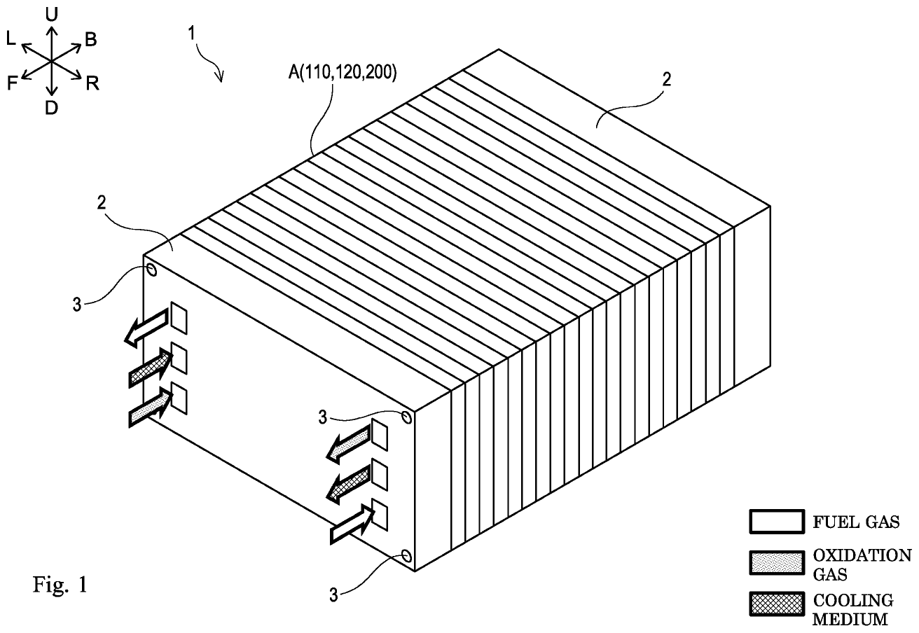

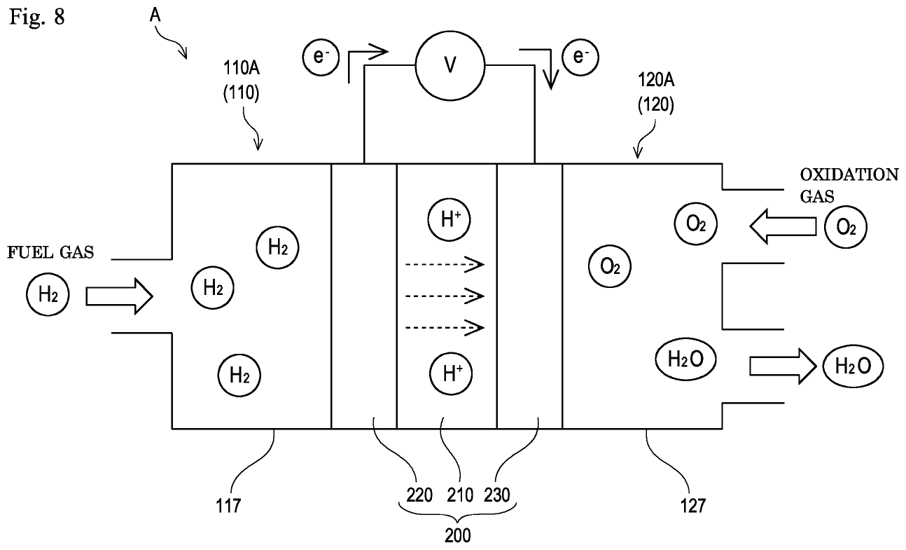

First, an outline of a fuel cell 1 provided with a separator 100 according to a first embodiment of the present invention will be described with reference to FIGS. 1 and 8.

The fuel cell 1 generates power by an electrochemical reaction. For example, the fuel cell 1 is used as a power supply for driving a motor or the like mounted on a vehicle. The fuel cell 1 generates power by an electrochemical reaction using fuel gas that is gas containing hydrogen and oxidation gas that is gas containing oxygen (see FIG. 8). As the fuel cell 1, for example, a fuel cell such as a polymer electrolyte fuel cell (PEFC) can be employed.

The fuel cell 1 is formed by stacking single cells (unit cells) A (see FIG. 8) that are basic units of power generation by an electrochemical reaction. As illustrated in FIG. 1, the fuel cell 1 is formed as a structural body (fuel cell stack) in which a plurality of the single cells A are stacked, and both end portions of the stacked single cells A in a stacking direction are sandwiched between end flanges 2 and fastened by fastening bolts 3.

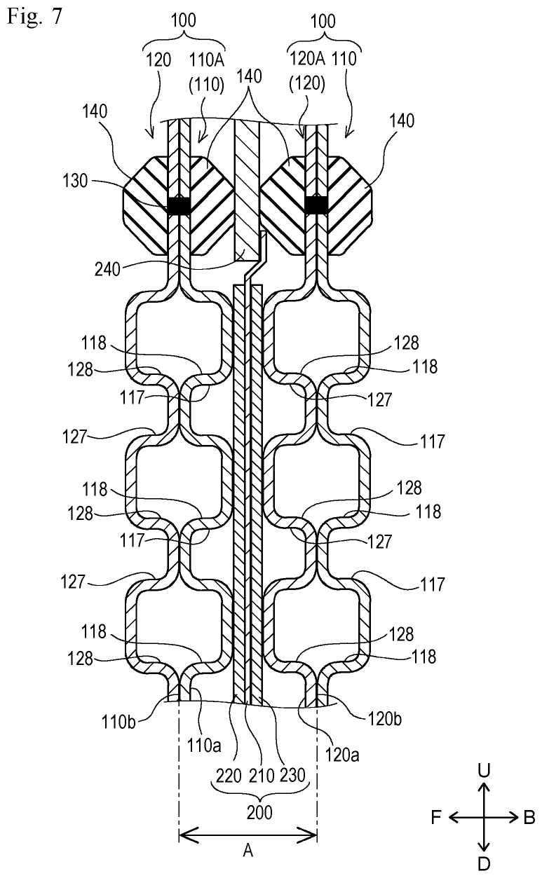

As illustrated in FIG. 8, the single cell A is formed by further sandwiching a membrane electrode assembly 200 in which an electrolyte membrane portion 210 is sandwiched between an anode 220 and a cathode 230 by an anode separator 110 and a cathode separator 120 (see also FIG. 7). Fuel gas used for power generation is fed to the membrane electrode assembly 200 through the anode separator 110, and oxidation gas is fed to the membrane electrode assembly 200 through the cathode separator 120. Note that the anode separator 110, the cathode separator 120, and the membrane electrode assembly 200 will be described in detail later.

In the present embodiment, the fuel cell 1 is formed in a substantially rectangular parallelepiped shape in which the stacking direction of the single cells A is oriented in the horizontal direction (front-rear direction). Fuel gas, oxidation gas, and a cooling medium (for example, water or the like) for cooling the separator 100 are fed to the fuel cell 1 through an appropriate feed line (not illustrated). Furthermore, the fuel gas, the oxidation gas, and the cooling medium fed into the fuel cell 1 and used for power generation and cooling are discharged through an appropriate discharge line (not illustrated).

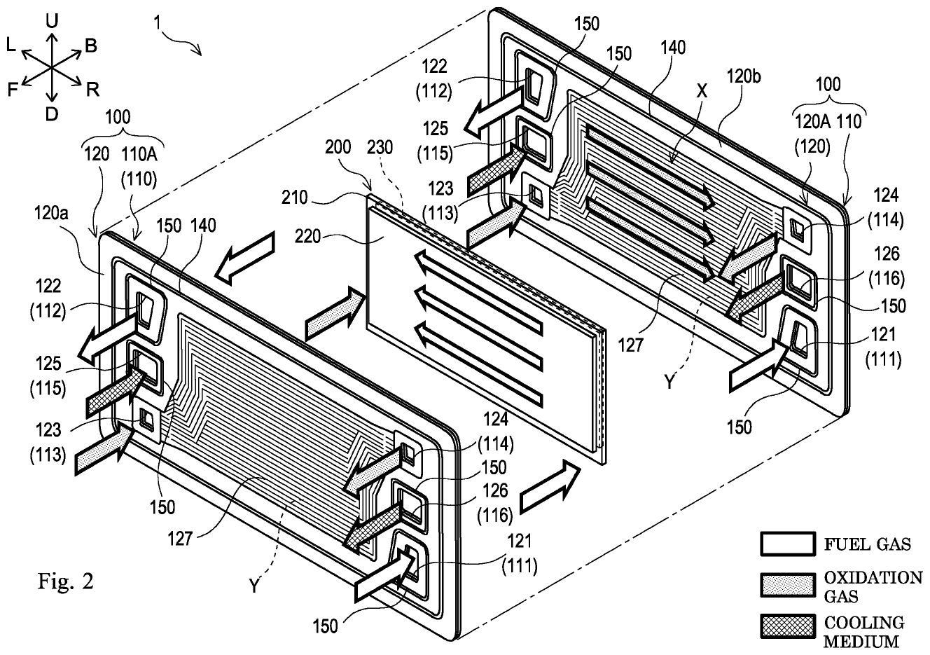

In the present embodiment, among the single cells A adjacent to each other in the stacking direction, the anode separator 110 of one single cell A and the cathode separator 120 of the other single cell A facing each other are joined, and the separator 100 (sometimes referred to as a bipolar plate) is formed as an integrated member (see FIG. 7). Hereinafter, the configuration of the separator 100 will be described in detail with reference to FIGS. 2 to 9.

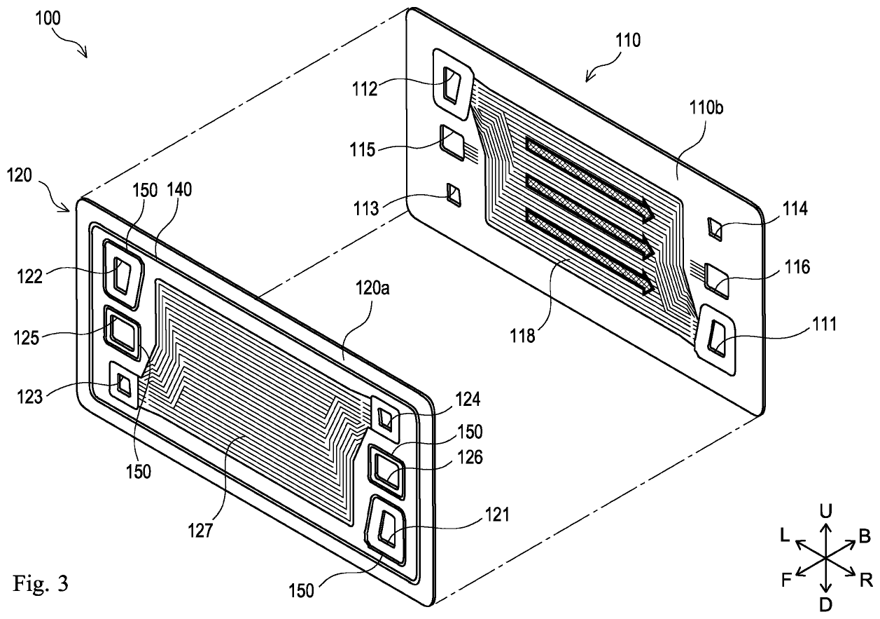

The separator 100 guides fuel gas and oxidation gas fed to the fuel cell 1 to the membrane electrode assembly 200. A cooling medium is fed to the separator 100. As illustrated in FIGS. 2 to 4, the separator 100 is formed in a substantially rectangular plate shape elongated in a left right direction in front view. As illustrated in FIG. 2, the separator 100 is disposed so as to be adjacent to the membrane electrode assembly 200. The separator 100 is formed of a material having excellent corrosion resistance and electrical conductivity in an acidic atmosphere. As a material of the separator 100, a metal material such as stainless steel or titanium can be adopted. As illustrated in FIG. 3, the separator 100 is formed by joining the anode separator 110 and the cathode separator 120 each having a plate shape. The separator 100 includes the anode separator 110, the cathode separator 120, a joint portion 130, an outer peripheral seal portion 140, and an opening seal portion 150.

The anode separator 110 illustrated in FIGS. 3, 4, 6 (a), and 7 guides fuel gas to the membrane electrode assembly 200 (anode 220). The anode separator 110 constitutes one side (rear side) in a thickness direction of the separator 100. The anode separator 110 is formed by appropriately pressing a plate-shaped metal material. The anode separator 110 includes an anode side surface 110a and an opposing surface 110b.

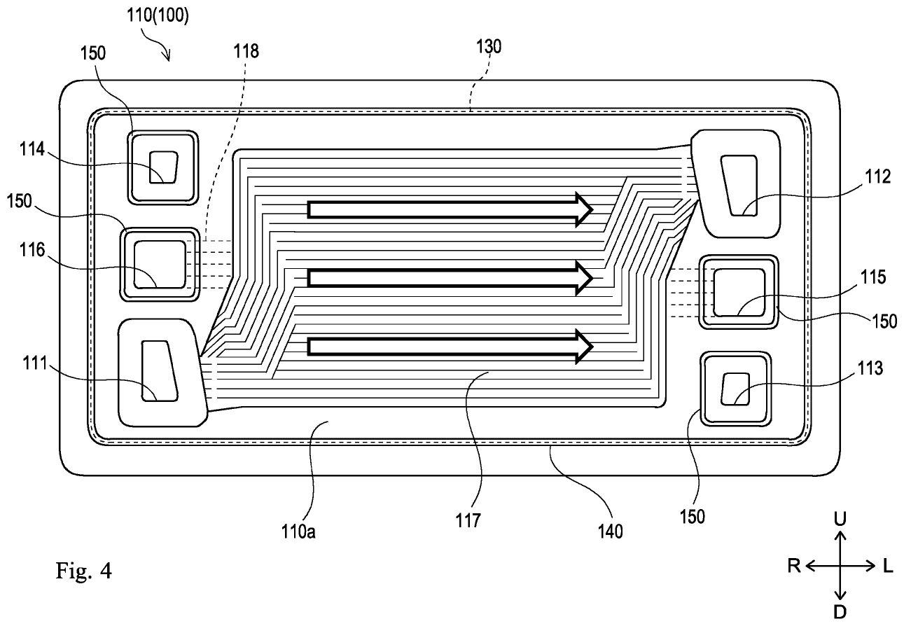

The anode side surface 110a illustrated in FIGS. 4 and 7 is a surface facing the anode 220 of the membrane electrode assembly 200 disposed behind the anode side surface 110a. Fuel gas fed to the fuel cell 1 flows through the anode side surface 110a.

The opposing surface 110b illustrated in FIGS. 3 and 7 is a surface facing the cathode separator 120. The cooling medium fed to fuel cell 1 flows through the opposing surface 110b.

The anode separator 110 includes a fuel gas feed hole 111, a fuel gas discharge hole 112, an oxidation gas feed hole 113, an oxidation gas discharge hole 114, a refrigerant feed hole 115, a refrigerant discharge hole 116, a fuel gas flow passage groove 117, and a refrigerant flow passage groove 118.

The fuel gas feed hole 111, the fuel gas discharge hole 112, the oxidation gas feed hole 113, the oxidation gas discharge hole 114, the refrigerant feed hole 115, and the refrigerant discharge hole 116 (Hereinafter, each of the holes may be referred to as “each hole” as necessary.) illustrated in FIGS. 3 and 4 are portions through which the fuel gas, the oxidation gas, and the cooling medium to be fed or discharged pass. Each hole is formed so as to penetrate the anode separator 110 in the thickness direction. Each hole is formed in a substantially rectangular shape in front view.

The fuel gas feed hole 111 is a portion through which the fuel gas fed to a side of the membrane electrode assembly 200 passes. The fuel gas feed hole 111 is located at a lower right corner of the anode separator 110.

The fuel gas discharge hole 112 is a portion through which the fuel gas discharged from the side of the membrane electrode assembly 200 passes. The fuel gas discharge hole 112 is located at an upper left corner of the anode separator 110. That is, the fuel gas discharge hole 112 is positioned diagonally to the fuel gas feed hole 111.

The oxidation gas feed hole 113 is a portion through which the oxidation gas fed to the side of the membrane electrode assembly 200 passes. The oxidation gas feed hole 113 is located at a lower left corner of the anode separator 110.

The oxidation gas discharge hole 114 is a portion through which the oxidation gas discharged from the side of the membrane electrode assembly 200 passes. The oxidation gas discharge hole 114 is located at an upper right corner of the anode separator 110. That is, the oxidation gas discharge hole 114 is positioned diagonally to the oxidation gas feed hole 113.

The refrigerant feed hole 115 is a portion through which the cooling medium fed to the separator 100 passes. The refrigerant feed hole 115 is located between the fuel gas discharge hole 112 and the oxidation gas feed hole 113 in a left part of the anode separator 110.

The refrigerant discharge hole 116 is a portion through which the cooling medium discharged from the separator 100 passes. The refrigerant discharge hole 116 is located between the fuel gas feed hole 111 and the oxidation gas discharge hole 114 in a right part of the anode separator 110.

Note that the position, shape, and size of each hole of the anode separator 110 in the present embodiment are merely examples, and are not limited to those illustrated in FIG. 4 and the like, and can be changed as appropriate.

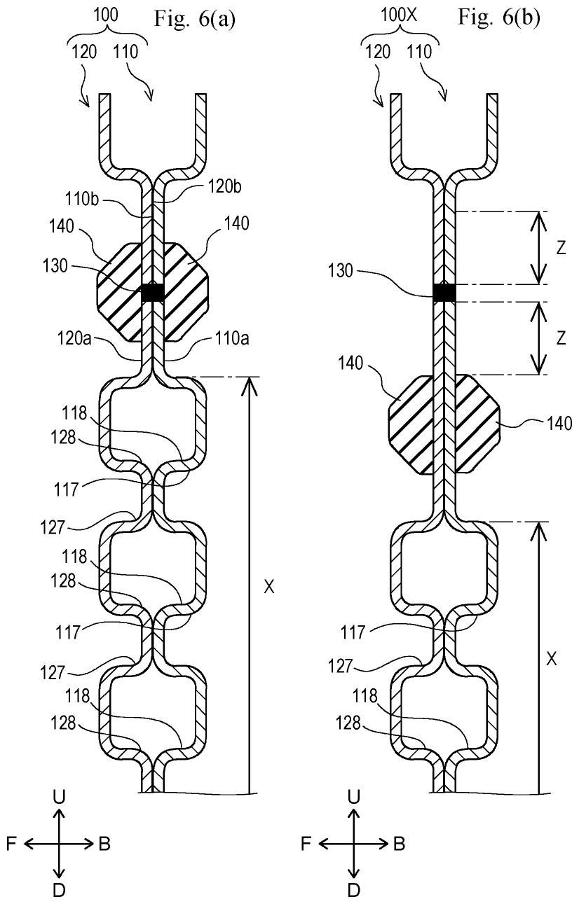

The fuel gas flow passage groove 117 illustrated in FIGS. 4 and 6(a) is a flow path of the fuel gas flowing through the anode side surface 110a. The fuel gas flow passage groove 117 is formed so as to communicate the fuel gas feed hole 111 with the fuel gas discharge hole 112. As illustrated in FIG. 6(a), the fuel gas flow passage groove 117 is formed so as to be recessed forward on the anode side surface 110a. As illustrated in FIG. 4, a plurality of the fuel gas flow passage grooves 117 are formed so as to be arranged in parallel substantially in an up-down direction. The plurality of fuel gas flow passage grooves 117 are formed to have a substantially rectangular shape as a whole in rear view.

The refrigerant flow passage groove 118 illustrated in FIGS. 3 and 6(a) is a flow path of the cooling medium flowing through the opposing surface 110b. The refrigerant flow passage groove 118 is formed so as to communicate the refrigerant feed hole 115 with the refrigerant discharge hole 116. As illustrated in FIG. 6(a), the refrigerant flow passage groove 118 is formed to be recessed rearward on the opposing surface 110b. As illustrated in FIG. 3, a plurality of the refrigerant flow passage grooves 118 are formed so as to be arranged in parallel substantially in the up-down direction. The plurality of refrigerant flow passage grooves 118 are formed to have a substantially rectangular shape as a whole in front view.

The fuel gas flow passage grooves 117 and the refrigerant flow passage grooves 118 (Hereinafter, each of the grooves may be referred to as “each groove” as necessary.) are formed by forming irregularities in a part of the anode separator 110 by press working when the anode separator 110 is formed. That is, a portion where the anode side surface 110a is recessed forward by press working becomes the fuel gas flow passage groove 117, and a portion between protruding portions (portions recessed rearward) on the opposing surface 110b becomes the refrigerant flow passage groove 118 by an amount where the anode side surface 110a is recessed.

The cathode separator 120 illustrated in FIGS. 3, 5, 6(a), and 7 guides oxidation gas to the membrane electrode assembly 200 (cathode 230). The cathode separator 120 constitutes the other side (front side) in the thickness direction of the separator 100. The cathode separator 120 is formed by appropriately pressing a plate-shaped metal material. The cathode separator 120 includes a cathode side surface 120a and an opposing surface 120b.

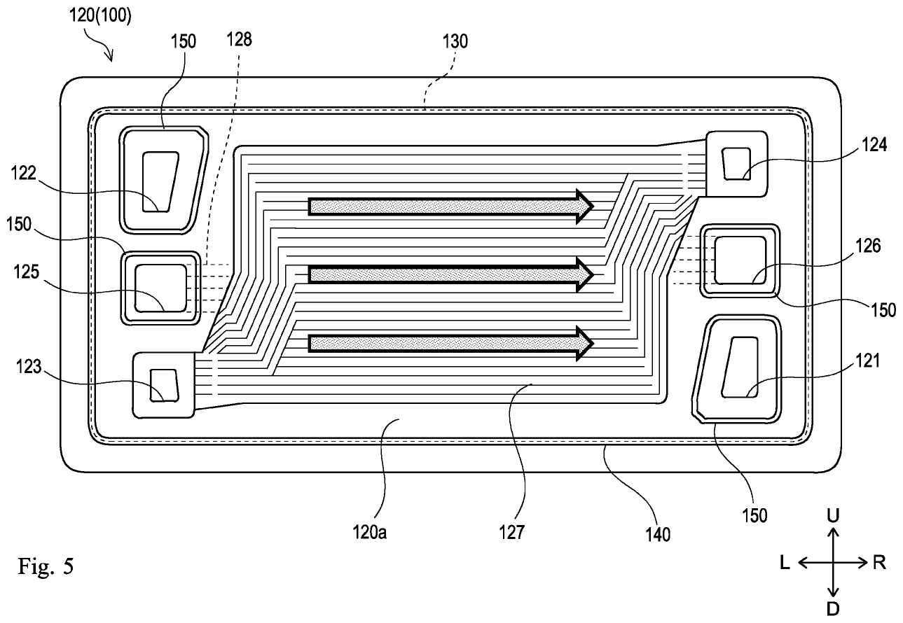

The cathode side surface 120a illustrated in FIGS. 5 and 7 is a surface facing the cathode 230 of the membrane electrode assembly 200 disposed in front of the cathode side surface 120a. The oxidation gas fed to the fuel cell 1 flows through the cathode side surface 120a.

The opposing surface 120b illustrated in FIG. 7 is a surface facing the anode separator 110. The cooling medium fed to the fuel cell 1 flows through the opposing surface 120b.

The cathode separator 120 includes a fuel gas feed hole 121, a fuel gas discharge hole 122, an oxidation gas feed hole 123, an oxidation gas discharge hole 124, a refrigerant feed hole 125, a refrigerant discharge hole 126, an oxidation gas flow passage groove 127, and a refrigerant flow passage groove 128.

The fuel gas feed hole 121, the fuel gas discharge hole 122, the oxidation gas feed hole 123, the oxidation gas discharge hole 124, the refrigerant feed hole 125, and the refrigerant discharge hole 126 (Hereinafter, each of the holes may be referred to as “each hole” as necessary.) illustrated in FIG. 5 are portions through which the fuel gas, the oxidation gas, and the cooling medium to be fed or discharged pass. Each hole is formed so as to penetrate the cathode separator 120 in the thickness direction. Each hole of the cathode separator 120 communicates with each hole of the anode separator 110.

Each hole (the fuel gas feed hole 121, the fuel gas discharge hole 122, the oxidation gas feed hole 123, the oxidation gas discharge hole 124, the refrigerant feed hole 125, and the refrigerant discharge hole 126) of the cathode separator 120 is provided at a position corresponding to the each hole (the fuel gas feed hole 111, the fuel gas discharge hole 112, the oxidation gas feed hole 113, the oxidation gas discharge hole 114, the refrigerant feed hole 115, and the refrigerant discharge hole 116) of the anode separator 110. Note that the description of each hole of the cathode separator 120 is omitted.

The oxidation gas flow passage groove 127 illustrated in FIGS. 5 and 6(a) is a flow path of the oxidation gas flowing through the cathode side surface 120a. The oxidation gas flow passage groove 127 is formed so as to communicate the oxidation gas feed hole 123 with the oxidation gas discharge hole 124. As illustrated in FIG. 6(a), the oxidation gas flow passage groove 127 is formed so as to be recessed rearward on the cathode side surface 120a. As illustrated in FIG. 5, a plurality of the oxidation gas flow passage grooves 127 are formed so as to be arranged in parallel substantially in the up-down direction. The plurality of oxidation gas flow passage grooves 127 are formed to have a substantially rectangular shape as a whole in rear view.

The refrigerant flow passage groove 128 illustrated in FIGS. 5 and 6(a) is a flow path of the cooling medium flowing through the opposing surface 120b. The refrigerant flow passage groove 128 is formed so as to communicate the refrigerant feed hole 125 with the refrigerant discharge hole 126. As illustrated in FIG. 6(a), the refrigerant flow passage groove 128 is formed to be recessed forward on the opposing surface 120b. Similarly to the refrigerant flow passage grooves 118 of the anode separator 110, a plurality of the refrigerant flow passage grooves 128 are formed. As illustrated in FIG. 6(a), the refrigerant flow passage groove 128 forms a space through which the cooling medium flows together with the refrigerant flow passage groove 118 of the anode separator 110.

The oxidation gas flow passage grooves 127 and the refrigerant flow passage grooves 128 (Hereinafter, each of the grooves may be referred to as “each groove” as necessary.) are formed by forming irregularities by press working similarly to the each groove of the anode separator 110.

The joint portion 130 illustrated in FIGS. 4, 5, and 6(a) joins the anode separator 110 and the cathode separator 120. The joint portion 130 is formed by welding (for example, laser welding) outer peripheral portions of the anode separator 110 and the cathode separator 120 with the opposing surface 110b and the opposing surface 120b facing each other. The joint portion 130 constitutes a seal that suppresses leakage of a cooling medium.

As illustrated in FIGS. 4 and 5, the joint portion 130 is formed so as to extend over the entire circumference of the outer peripheral portions of the anode separator 110 and the cathode separator 120 (the outer portions of the anode separator 110 and the cathode separator 120 in the front view) so as to surround the each hole and the each groove of the anode separator 110 and the cathode separator 120. That is, the joint portion 130 is formed so as to be located outside the each hole and the each groove. Furthermore, the joint portion 130 is continuously formed so as to go around the outer peripheral portions of the anode separator 110 and the cathode separator 120.

The outer peripheral seal portion 140 illustrated in FIGS. 4, 5, 6(a), and 9 suppresses leakage of the fuel gas and the oxidation gas flowing through the separator 100. In the present embodiment, the outer peripheral seal portion 140 is provided on each of the anode side surface 110a of the anode separator 110 and the cathode side surface 120a of the cathode separator 120. The outer peripheral seal portion 140 is formed of an elastic rubber member or the like.

The outer peripheral seal portion 140 is formed to extend along the joint portion 130. The outer peripheral seal portion 140 is formed so as to overlap with the joint portion 130 when viewed in the thickness direction of the separator 100. In the outer peripheral seal portion 140, the entire outer peripheral seal portion 140 in an extending direction (a direction in which the outer peripheral seal portion 140 extends) overlaps the joint portion 130 as viewed in the thickness direction of the separator 100.

Furthermore, the outer peripheral seal portion 140 is formed over the entire circumference of the outer peripheral parts of the anode separator 110 and the cathode separator 120 so as to surround the each hole and the each groove of the anode separator 110 and the cathode separator 120. That is, the outer peripheral seal portion 140 is formed so as to be located outside the each hole and the each groove. Furthermore, the outer peripheral seal portion 140 is continuously formed so as to go around outer peripheral portions of the anode separator 110 and the cathode separator 120.

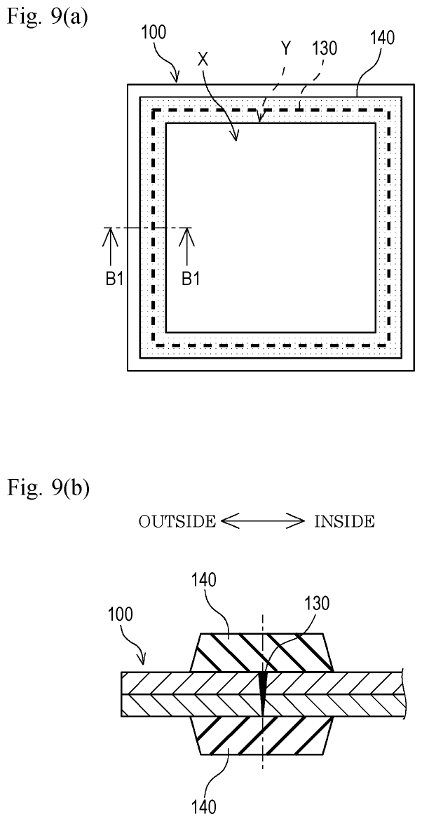

In the present embodiment, as illustrated in FIGS. 4, 5, 6(a), and 9(b), the outer peripheral seal portion 140 of the anode separator 110 and the outer peripheral seal portion 140 of the cathode separator 120 are formed so as to coincide with each other when viewed in the thickness direction of the separator 100. Furthermore, in the present embodiment, as illustrated in FIG. 9, over the entire circumference of the outer peripheral seal portion 140, a center in the width direction (direction orthogonal to the extending direction of the outer peripheral seal portion 140) of the outer peripheral seal portion 140 is formed to coincide with a center in the width direction (direction orthogonal to the extending direction of the joint portion 130) of the joint portion 130. Note that, in FIG. 9(b), the center in the width direction of the outer peripheral seal portion 140 and the center in the width direction of the joint portion 130 are indicated by alternate long and short dash lines.

The opening seal portion 150 illustrated in FIGS. 4 and 5 suppresses leakage of the fuel gas and the oxidation gas passing through the each hole of the separator 100. As illustrated in FIG. 4, the opening seal portion 150 is formed on the anode side surface 110a of the anode separator 110 so as to surround respective openings of the oxidation gas feed hole 113, the oxidation gas discharge hole 114, the refrigerant feed hole 115, and the refrigerant discharge hole 116. Furthermore, as illustrated in FIG. 5, the opening seal portion 150 is formed on the cathode side surface 120a of the cathode separator 120 so as to surround the respective openings of the fuel gas feed hole 121, the fuel gas discharge hole 122, the refrigerant feed hole 125, and the refrigerant discharge hole 126. The opening seal portion 150 is formed over the entire circumference of each of the openings. Similarly to the outer peripheral seal portion 140, the opening seal portion 150 is formed of an elastic rubber member or the like.

The outer peripheral seal portion 140 and the opening seal portion 150 as described above are formed on the anode separator 110 and the cathode separator 120 by, for example, injection molding. In the present embodiment, the outer peripheral seal portion 140 and the opening seal portion 150 are formed on the anode separator 110 and the cathode separator 120 after the anode separator 110 and the cathode separator 120 are joined to each other. At this time, the outer peripheral seal portion 140 is formed so as to overlap the joint portion 130.

Note that the method of providing the outer peripheral seal portion 140 and the opening seal portion 150 on the separator 100 is not limited to the injection molding. More optimally, it is desirable to adopt a method in which the outer peripheral seal portion 140 is not directly molded on the separator 100 as in the injection molding, and the outer peripheral seal portion 140 and the opening seal portion 150 formed in advance on another sheet or the like are bonded to the separator 100. According to the above method, even in a case where the opening seal portion 150 is formed so as to cross the each groove after the each groove is formed in the anode separator 110 and the cathode separator 120, it is possible to suppress collapse of a shape of the each groove due to an injection pressure during the injection molding. Furthermore, according to the above method, unlike the method by the injection molding, processing of a gate and the like are unnecessary.

Hereinafter, the configuration of the membrane electrode assembly 200 will be described in detail with reference to FIGS. 2, 7 and 8.

The membrane electrode assembly 200 generates electric power by an electrochemical reaction using fuel gas and oxidation gas. The membrane electrode assembly 200 is formed in a substantially rectangular plate shape elongated in the left-right direction in front view. The membrane electrode assembly 200 is formed into a shape substantially corresponding to the plurality of fuel gas flow passage grooves 117 and the plurality of oxidation gas flow passage grooves 127. The membrane electrode assembly 200 includes the electrolyte membrane portion 210, the anode 220, the cathode 230, and a sheet portion 240.

The electrolyte membrane portion (ion exchange membrane) 210 is a membrane-like electrolyte member. The electrolyte membrane portion 210 has a property of passing hydrogen ions (protons) obtained by removing electrons from hydrogen atoms in the fuel gas and not passing the fuel gas and the oxidation gas. The electrolyte membrane portion 210 is formed in a substantially rectangular membrane (plate) shape elongated in the left-right direction in front view. As the electrolyte membrane portion 210, various electrolyte membranes used for a fuel cell, such as a fluorine-based electrolyte and a hydrocarbon (HC)-based electrolyte, can be adopted.

The anode (hydrogen electrode) 220 illustrated in FIGS. 7 and 8 is an electrode on a side into which a current flows from an external circuit connected to the cathode 230 to be described later (electrons are emitted to the external circuit). The anode 220 is formed in a substantially rectangular film (plate) shape elongated in the left-right direction in front view. The anode 220 is formed to have an area smaller than an area of the electrolyte membrane portion 210. The anode 220 is disposed on a front surface of the electrolyte membrane portion 210. The anode 220 generates hydrogen ions and electrons by causing an oxidation reaction of hydrogen in the fuel gas to proceed. The anode 220 is formed by stacking a catalyst layer that causes an oxidation reaction to proceed and a gas diffusion layer that feeds the fuel gas to the catalyst layer.

The cathode 230 is an electrode on a side where a current flows to an external circuit (electrons flow from the external circuit). The cathode 230 is formed in a substantially rectangular film (plate) shape elongated in the left-right direction in front view. The cathode 230 is formed to have an area substantially equal to an area of the anode 220. The cathode 230 is connected to the anode 220 via an appropriate external circuit. The cathode 230 is disposed on a rear surface of the electrolyte membrane portion 210. In the cathode 230, hydrogen ions having passed through the electrolyte membrane portion 210 take in electrons flowing from the external circuit and promote a reduction reaction to combine with oxygen in the oxidation gas, thereby generating water. The cathode 230 is formed by stacking a catalyst layer that causes a reduction reaction to proceed and a gas diffusion layer that feeds an oxidation gas to the catalyst layer.

The sheet portion 240 illustrated in FIG. 7 is a portion constituting an outer peripheral portion of the membrane electrode assembly 200. The sheet portion 240 is provided on one surface (a front surface in the present embodiment) of the outer peripheral portion (portion located outside the anode 220 and the cathode 230) of the electrolyte membrane portion 210. The sheet portion 240 is formed in a frame shape surrounding the outer peripheral portion of the electrolyte membrane portion 210. Note that, in FIG. 2, illustration of the sheet portion 240 is omitted. The sheet portion 240 is formed by, for example, stacking sheets formed of rubber on both surfaces of a film such as PEN. Both the surfaces of the sheet portion 240 abut on the outer peripheral seal portion 140.

As illustrated in FIGS. 2 and 7, the separator 100 and the membrane electrode assembly 200 as described above are alternately disposed so as to be adjacent to each other in a front-rear direction. Note that, although one membrane electrode assembly 200 and a pair of separators 100 are illustrated in FIGS. 2 and 7, a necessary number of membrane electrode assemblies 200 and separators 100 are disposed according to a required power generation amount.

The separator 100 and the membrane electrode assembly 200 are alternately stacked to form a plurality of layers of single cells A. In the present embodiment, as illustrated in FIG. 7, a certain membrane electrode assembly 200, and the anode separator 110 and the cathode separator 120 facing the membrane electrode assembly 200 among a pair of separators 100 disposed in front of and behind the membrane electrode assembly 200 constitute the single cell A. Hereinafter, among the separators 100, the anode separator 110 and the cathode separator 120 constituting a certain single cell A will be referred to as an “anode separator 110A” and a “cathode separator 120A”, respectively.

As illustrated in FIG. 7, the outer peripheral seal portion 140 of the anode separator 110A and the outer peripheral seal portion 140 of the cathode separator 120A constituting the single cell A are disposed so as to face each other. In the present embodiment, the outer peripheral seal portions 140 of the anode separator 110A and the cathode separator 120A are brought into contact with the front surface and the rear surface of the sheet portion 240 of the electrolyte membrane portion 210 in the membrane electrode assembly 200. That is, the outer peripheral seal portions 140 face each other via the sheet portion 240.

A space in which airtightness is maintained is formed by being surrounded by the outer peripheral seal portions 140 facing each other. In the above space, the membrane electrode assembly 200 is disposed, and power generation using the fuel gas or the oxidation gas fed to the fuel cell 1 is performed. Hereinafter, a portion where the each groove of the separator 100 is formed in the space surrounded by each of the outer peripheral seal portions 140 is referred to as a “power generation portion X”. By stacking the plurality of separators 100, a plurality of power generation portions X is formed for each single cell A. The power generation portions X communicate with each other via the each hole of each of the separators 100 (see FIG. 2).

Furthermore, a space surrounded by the joint portion 130 and to which the cooling medium is fed is formed inside each of the separators 100. Hereinafter, the space surrounded by the joint portion 130 will be referred to as a “cooling portion Y” (see FIG. 9(a)). The cooling portions Y communicate with each other via the each hole of each of the separators 100 (see FIG. 2).

Hereinafter, how the fuel gas, the oxidation gas, and the cooling medium are fed to the fuel cell 1 will be described with reference to FIGS. 2 to 5 and FIG. 7.

As illustrated in FIGS. 2 and 4, a part of the fuel gas fed to each membrane electrode assembly 200 of the fuel cell 1 through the fuel gas feed hole 121 and the fuel gas feed hole 111 of the separator 100 flows through the fuel gas flow passage groove 117, and is discharged through the fuel gas discharge hole 112 and fuel gas discharge hole 122. A part of the fuel gas is fed to the anode 220 when flowing through the fuel gas flow passage groove 117. Furthermore, another part of the fuel gas (the fuel gas not flowing through the fuel gas flow passage groove 117) fed through the fuel gas feed hole 121 and the fuel gas feed hole 111 of the separator 100 is fed to the fuel gas feed hole 121 and the fuel gas feed hole 111 of the separator 100 on a downstream side (rear side) in a feed direction. Furthermore, the fuel gas discharged through the fuel gas discharge hole 112 and the fuel gas discharge hole 122 is fed to the fuel gas discharge hole 112 and the fuel gas discharge hole 122 of the separator 100 on a downstream side (front side) in a discharge direction.

Furthermore, as illustrated in FIGS. 2 and 5, a part of the oxidation gas fed to each membrane electrode assembly 200 of the fuel cell 1 through the oxidation gas feed hole 123 and the oxidation gas feed hole 113 of the separator 100 flows through the oxidation gas flow passage groove 127 of the separator 100 on the downstream side (rear side) in the feed direction, and is discharged through the oxidation gas discharge hole 114 and the oxidation gas discharge hole 124. A part of the oxidation gas is fed to the cathode 230 when flowing through the oxidation gas flow passage groove 127. Furthermore, another part of the oxidation gas fed through the oxidation gas feed hole 123 and the oxidation gas feed hole 113 of the separator 100 (the oxidation gas not flowing through the oxidation gas flow passage groove 127) is fed to the oxidation gas feed hole 123 and the oxidation gas feed hole 113 of the separator 100 on the downstream side in the feed direction. Furthermore, the oxidation gas discharged through the oxidation gas discharge hole 114 and the oxidation gas discharge hole 124 is fed to the oxidation gas discharge hole 114 and the oxidation gas discharge hole 124 of the separator 100 on the downstream side (front side) in the discharge direction.

Furthermore, as illustrated in FIGS. 2 and 3, a part of the cooling medium fed to the separator 100 through the refrigerant feed hole 125 of the separator 100 flows through the refrigerant flow passage groove 118 and the refrigerant flow passage groove 128, and is discharged through the refrigerant discharge hole 126. The cooling medium cools the separator 100 when flowing through the refrigerant flow passage groove 118 and the refrigerant flow passage groove 128. Accordingly, the fuel cell 1 that generates heat in association with power generation can be cooled. Furthermore, another part of the cooling medium (the cooling medium not flowing through the refrigerant flow passage groove 118 and the refrigerant flow passage groove 128) fed through the refrigerant feed hole 125 of the separator 100 is fed to the refrigerant feed hole 125 of the separator 100 on the downstream side (rear side) in the feed direction through the refrigerant feed hole 115. Furthermore, the cooling medium discharged through the refrigerant discharge hole 126 is fed to the refrigerant discharge hole 116 and the refrigerant discharge hole 126 of the separator 100 on the downstream side (front side) in the discharge direction.

Hereinafter, a state of power generation in the single cell A of the fuel cell 1 as described above will be described with reference to FIGS. 7 and 8.

The fuel gas flowing through the fuel gas flow passage groove 117 is fed to the anode 220. In the fuel gas, an oxidation reaction of hydrogen in the fuel gas proceeds in the anode 220, and hydrogen ions and electrons are generated.

The hydrogen ions generated at the anode 220 pass through the electrolyte membrane portion 210 and move to the cathode 230.

Furthermore, the electrons generated in the anode 220 reach the cathode 230 via an external circuit.

Furthermore, the oxidation gas flowing through the oxidation gas flow passage groove 127 is fed to the cathode 230. In the cathode 230, a reduction reaction of oxygen and hydrogen ions, and electrons in the oxidation gas proceeds to generate water.

Along with the chemical reaction, electrons move through an external circuit connecting the anode 220 and the cathode 230, whereby a current flows through the external circuit. In this way, the fuel cell 1 can generate power.

In the separator 100 as described above, by overlapping the outer peripheral seal portion 140 and the joint portion 130 when viewed in the thickness direction of the separator 100, an area occupied by the outer peripheral seal portion 140 and the joint portion 130 in the separator 100 can be reduced. That is, an area occupied by the power generation portion X and the cooling portion Y in the separator 100 can be made relatively large, and an area of the separator 100 can be effectively used.

Furthermore, FIG. 6(b) illustrates a separator 100X to be compared with the separator 100 as described above. The separator 100X is formed by welding the anode separator 110 and the cathode separator 120 after the outer peripheral seal portion 140 is formed on the anode separator 110 and the cathode separator 120. In the separator 100X formed in this manner, it is necessary to secure a space Z for pressing the outside and the inside of the joint portion 130 with an appropriate jig used for welding. Since the outer peripheral seal portion 140 cannot be installed in the space Z, the separator 100X is provided with the outer peripheral seal portion 140 inside with the space Z from the joint portion 130.

In the separator 100 according to the present embodiment illustrated in FIG. 6(a), the outer peripheral seal portion 140 is formed on the anode separator 110 and the cathode separator 120 after the anode separator 110 and the cathode separator 120 are welded. According to this, unlike the separator 100X to be compared illustrated in FIG. 6(b), it is not necessary to provide the outer peripheral seal portion 140 with the space Z, and the outer peripheral seal portion 140 and the joint portion 130 can be overlapped when viewed in the thickness direction of the separator 100. Therefore, unlike the case where the outer peripheral seal portion 140 is located inside the joint portion 130, an area of a region surrounded by the outer peripheral seal portion 140 can be made relatively large, and furthermore, an area of the power generation portion X (an area of a portion occupied by a region where the each groove is formed), which is a portion for feeding the fuel gas or the oxidation gas to the membrane electrode assembly 200, can be made large. Consequently, the power generation efficiency of fuel cell 1 can be improved by effectively using an area of the separator 100 without increasing an outer shape of the separator 100.

Furthermore, for example, in a case where the anode separator 110 and the cathode separator 120 are welded after surface treatment, it is conceivable that the surface treatment disappears at the joint portion 130 and a base material having poor corrosion resistance is exposed. According to the separator 100 of the present embodiment, since the outer peripheral seal portion 140 and the joint portion 130 overlap each other when viewed in the thickness direction of the separator 100, it is possible to suppress exposure of the joint portion 130. Accordingly, it is possible to suppress contact of the joint portion 130 with a fluid or the like and to improve corrosion resistance of the separator 100. Note that, instead of the method of welding the anode separator 110 and the cathode separator 120 after the surface treatment, a method of performing the surface treatment after the anode separator 110 and the cathode separator 120 are welded and forming the outer peripheral seal portion 140 thereon may be adopted.

As described above, the separator 100 according to the present embodiment is
a separator 100 that is formed in a plate shape, constitutes a fuel cell 1 and is disposed so as to be adjacent to an electrolyte membrane (membrane electrode assembly 200) to which fuel gas and oxidation gas are fed, the separator including:
an anode separator 110 including a fuel gas flow passage surface (anode side surface 110a) on which a flow path (fuel gas flow passage groove 117) of the fuel gas is formed;
a cathode separator 120 including an oxidation gas flow passage surface (cathode side surface 120a) on which a flow path (oxidation gas flow passage groove 127) of the oxidation gas is formed;
a joint portion 130 that extends so as to surround the flow path of the fuel gas (fuel gas flow passage groove 117) and the flow path of the oxidation gas (oxidation gas flow passage groove 127), and joins the anode separator 110 and the cathode separator 120 to each other; and
a seal portion (outer peripheral seal portion 140) provided on at least one of the fuel gas flow passage surface (anode side surface 110a) and the oxidation gas flow passage surface (cathode side surface 120a), extending along the joint portion 130, and formed so as to overlap the joint portion 130 when viewed in a thickness direction of the separator 100.

With such a configuration, the area of the separator 100 can be effectively used. That is, by overlapping the seal portion (outer peripheral seal portion 140) and the joint portion 130 when viewed in the thickness direction of the separator 100, an area occupied by the seal portion (outer peripheral seal portion 140) and the joint portion 130 in the separator 100 can be reduced. As a result, in the separator 100, an area occupied by the fuel gas flow passage groove 117, the oxidation gas flow passage groove 127, and the refrigerant flow passage grooves 118 and 128 can be increased, and an area of the separator 100 can be effectively used. Furthermore, for example, unlike the case where the seal portion (outer peripheral seal portion 140) is located inside the joint portion 130, an area of the portion (power generation portion X) surrounded by the seal portion (outer peripheral seal portion 140) can be made relatively large, and eventually, an area of a portion for feeding the fuel gas or the oxidation gas to the electrolyte membrane (membrane electrode assembly 200) can be made large. Accordingly, the power generation efficiency of the fuel cell 1 can be improved.

Furthermore, the seal portion (outer peripheral seal portion 140) is formed over the entire circumference of the joint portion 130.

With such a configuration, the area of the separator 100 can be more effectively used.

Note that the anode side surface 110a is an embodiment of a fuel gas flow passage surface.

Furthermore, the fuel gas flow passage groove 117 is an embodiment of a flow path of fuel gas.

Furthermore, the cathode side surface 120a is an embodiment of an oxidation gas flow passage surface.

Furthermore, the oxidation gas flow passage groove 127 is an embodiment of a flow path for oxidation gas.

Furthermore, the outer peripheral seal portion 140 is an embodiment of a seal portion.

Furthermore, the membrane electrode assembly 200 is an embodiment of an electrolyte membrane.

Although the first embodiment of the present invention has been described above, the present invention is not limited to the above configuration, and various modifications can be made within the scope of the invention described in the claims.

For example, in the present embodiment, an example in which the outer peripheral seal portion 140 is provided on both the anode side surface 110a of the anode separator 110 and the cathode side surface 120a of the cathode separator 120 has been described, but the present invention is not limited to such an aspect. For example, the outer peripheral seal portion 140 may be provided only in one of the anode separator 110 and the cathode separator 120. In this case, the outer peripheral seal portion 140 is formed so as to be in contact with the other of the anode separator 110 and the cathode separator 120.

Furthermore, in the present embodiment, the example in which the outer peripheral seal portion 140 is formed over the entire circumference of the joint portion 130 has been described, but the present invention is not limited to such an aspect. For example, the outer peripheral seal portion 140 may be formed along a part of the joint portion 130 in the extending direction.

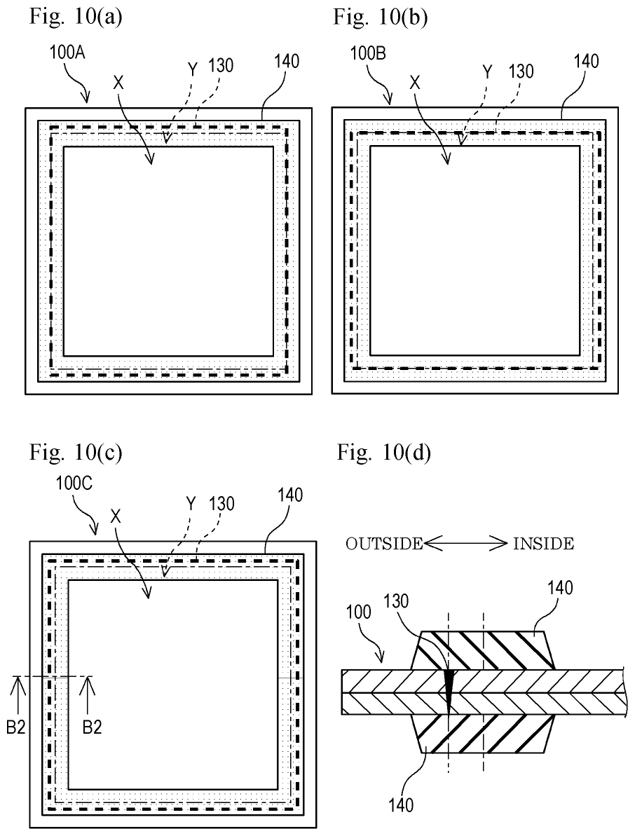

Furthermore, in the present embodiment, as illustrated in FIG. 9, the separator 100 is formed such that the center in the width direction of the outer peripheral seal portion 140 coincides with the center in the width direction of the joint portion 130, but the present invention is not limited to such an aspect. For example, as illustrated in another embodiment (second to fifth embodiments) illustrated in FIGS. 10 to 12, a position where the outer peripheral seal portion 140 is formed may be appropriately changed.

Hereinafter, another embodiment (second to fifth embodiments) of the separator 100 will be described.

In separators 100A, 100B, and 100C according to the second embodiment of the present invention illustrated in FIG. 10, at least a part of an outer peripheral seal portion 140 in the extending direction is formed at a position offset inward with respect to a joint portion 130 overlapping as viewed in the thickness direction. Note that FIG. 10(d) is a cross-sectional view illustrating an offset portion of the outer peripheral seal portion 140. In FIG. 10(d), the center in the width direction of the outer peripheral seal portion 140 and the center in the width direction of the joint portion 130 are indicated by alternate long and short dash lines.

In the separator 100A illustrated in FIG. 10(a), an example is illustrated in which an upper portion and a lower portion of the outer peripheral seal portion 140 are formed at positions offset inward with respect to an upper portion and a lower portion of the joint portion 130. More specifically, the center in the width direction of the upper portion and the lower portion of the outer peripheral seal portion 140 is formed to be located inside the center in the width direction of the upper portion and the lower portion of the joint portion 130 (see FIG. 10(d)).

In the separator 100B illustrated in FIG. 10(b), an example is illustrated in which a right portion and a left portion of the outer peripheral seal portion 140 are formed at positions offset inward with respect to a right portion and a left portion of the joint portion 130. More specifically, the center in the width direction of the right portion and the left portion of the outer peripheral seal portion 140 is formed to be located inside the center in the width direction of the right portion and the left portion of the joint portion 130 (see FIG. 10(d)).

In the separator 100C illustrated in FIG. 10(c), an example is illustrated in which the entire outer peripheral seal portion 140 is formed at a position offset inward with respect to the joint portion 130. More specifically, over the entire circumference of the outer peripheral seal portion 140, the center of the outer peripheral seal portion 140 in the width direction is formed to be located inside the center of the joint portion 130 in the width direction (see FIG. 10(d)).

The separators 100A, 100B, and 100C as described above also have substantially the same effects as the separator 100 according to the first embodiment. Furthermore, according to the separators 100A, 100B, and 100C as described above, an area of the cooling portion Y can be made relatively large. Accordingly, the separators 100A, 100B, and 100C can be effectively cooled by the cooling medium. More specifically, according to the separators 100A, 100B, and 100C, while the position of the joint portion 130 is located outside the separator 100 according to the first embodiment, the joint portion 130 and the outer peripheral seal portion 140 can overlap each other when viewed in the thickness direction of the separators 100A, 100B, and 100C. Thus, the separators 100A, 100B, and 100C can be more effectively cooled than the separator 100 according to the first embodiment.

As described above, in the separators 100A, 100B, and 100C according to the present embodiment,
at least a part of the seal portion (outer peripheral seal portion 140) is formed at a position offset inward with respect to the joint portion 130 overlapping as viewed in the thickness direction.

With such a configuration, an area of the portion (cooling portion Y) surrounded by the joint portion 130 can be relatively increased. Accordingly, in a case where a cooling medium for cooling the separators 100A, 100B, and 100C is fed to the portion (cooling portion Y) surrounded by the joint portion 130, the separators 100A, 100B, and 100C can be effectively cooled.

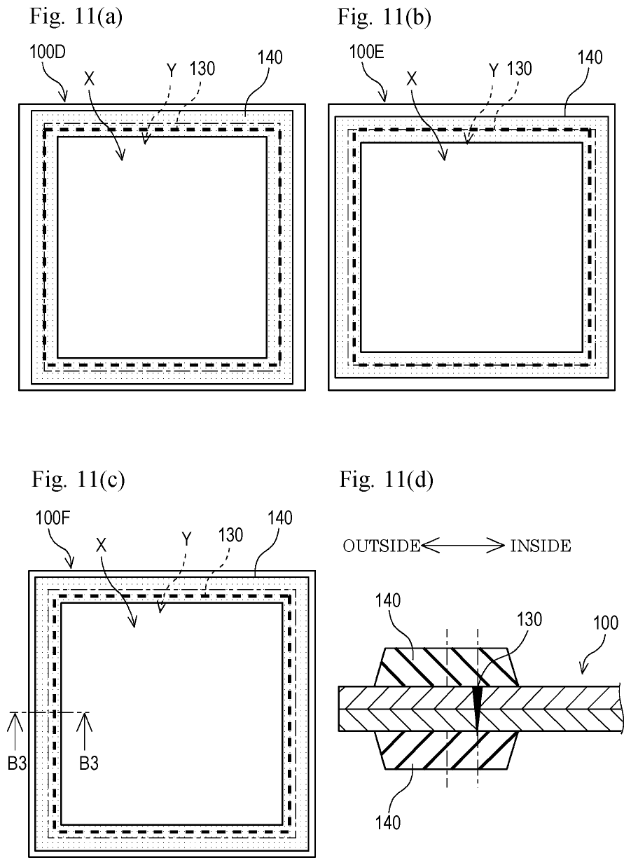

In separators 100D, 100E, and 100F according to the third embodiment of the present invention illustrated in FIG. 11, at least a part of an outer peripheral seal portion 140 in the extending direction is formed at a position offset outward with respect to a joint portion 130 overlapping as viewed in the thickness direction. Note that FIG. 11(d) is a cross-sectional view illustrating an offset portion of the outer peripheral seal portion 140. In FIG. 11(d), the center in the width direction of the outer peripheral seal portion 140 and the center in the width direction of the joint portion 130 are indicated by alternate long and short dash lines.

In the separator 100D illustrated in FIG. 11(a), an example is illustrated in which an upper portion and a lower portion of the outer peripheral seal portion 140 are formed at positions offset outward with respect to an upper portion and a lower portion of the joint portion 130. More specifically, the center in the width direction of the upper portion and the lower portion of the outer peripheral seal portion 140 is formed to be located outside the center in the width direction of the upper portion and the lower portion of the joint portion 130 (see FIG. 11(d)).

In the separator 100E illustrated in FIG. 11(b), an example is illustrated in which a right portion and a left portion of the outer peripheral seal portion 140 are formed at positions offset outward with respect to a right portion and a left portion of the joint portion 130. More specifically, the center in the width direction of the right portion and the left portion of the outer peripheral seal portion 140 is formed to be located outside the center in the width direction of the right portion and the left portion of the joint portion 130 (see FIG. 11(d)).

In the separator 100F illustrated in FIG. 11(c), an example is illustrated in which the entire outer peripheral seal portion 140 is formed at a position offset outward with respect to the joint portion 130. More specifically, over the entire circumference of the outer peripheral seal portion 140, the center in the width direction of the outer peripheral seal portion 140 is formed to be located outside the center in the width direction of the joint portion 130 (see FIG. 11(d)).

The separators 100D, 100E, and 100F as described above also have substantially the same effects as the separator 100 according to the first embodiment. Furthermore, according to the separators 100D, 100E, and 100F as described above, an area of the power generation portion X can be made relatively large. Accordingly, the power generation efficiency of the fuel cell 1 can be further improved. More specifically, according to the separators 100D, 100E, and 100F, while the position of the outer peripheral seal portion 140 is located outside the separator 100 according to the first embodiment, the joint portion 130 and the outer peripheral seal portion 140 can overlap each other when viewed in the thickness direction of the separators 100D, 100E, and 100F. Accordingly, the power generation efficiency of the fuel cell 1 can be further improved than the separator 100 according to the first embodiment.

As described above, the separators 100D, 100E, and 100F according to the present embodiment,
at least a part of the seal portion (outer peripheral seal portion 140) is formed at a position offset outward with respect to the joint portion 130 overlapping as viewed in the thickness direction.

With such a configuration, an area of the portion (power generation portion X) surrounded by the seal portion (outer peripheral seal portion 140) can be relatively increased. Accordingly, the power generation efficiency of the fuel cell 1 can be further improved.

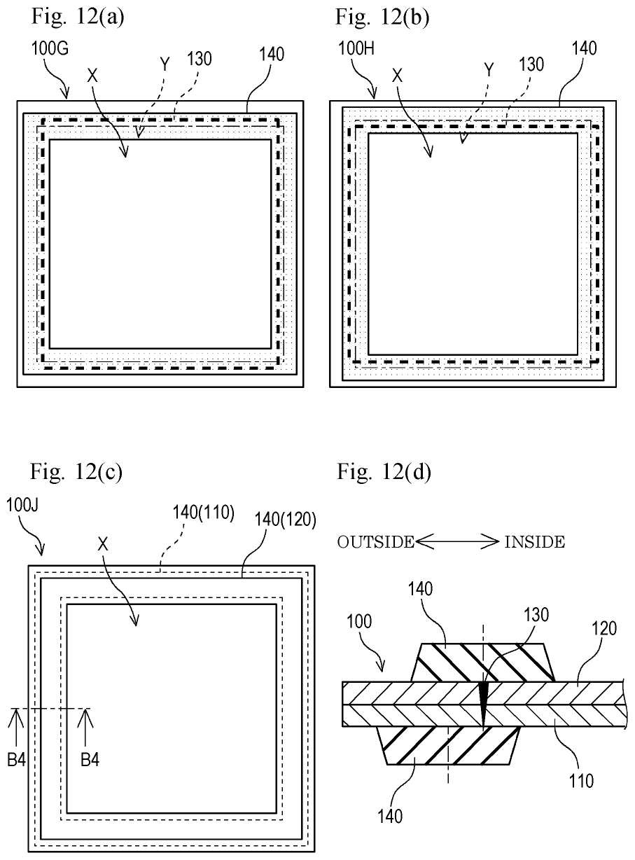

In separators 100G and 100H according to the fourth embodiment of the present invention illustrated in FIGS. 12(a) and (b), a part of an outer peripheral seal portion 140 is formed at a position offset inward with respect to a joint portion 130 overlapping as viewed in the thickness direction, and another part of the outer peripheral seal portion 140 is formed at a position offset outward with respect to the joint portion 130 overlapping as viewed in the thickness direction.

In the separator 100G illustrated in FIG. 12(a), an example is illustrated in which an upper portion and a lower portion of the outer peripheral seal portion 140 are formed at positions offset inward with respect to an upper portion and a lower portion of the joint portion 130, and a right portion and a left portion of the outer peripheral seal portion 140 are formed at positions offset outward with respect to a right portion and a left portion of the joint portion 130. More specifically, the center in the width direction of the upper portion and the lower portion of the outer peripheral seal portion 140 is located inside the center in the width direction of the upper portion and the lower portion of the joint portion 130 (see FIG. 10(d)), and the center in the width direction of the right portion and the left portion of the outer peripheral seal portion 140 is located outside the center in the width direction of the right portion and the left portion of the joint portion 130 (see FIG. 11(d)).

In the separator 100H illustrated in FIG. 12(b), an example is illustrated in which the upper portion and the lower portion of the outer peripheral seal portion 140 are formed at positions offset outward with respect to the upper portion and the lower portion of the joint portion 130, and the right portion and the left portion of the outer peripheral seal portion 140 are formed at positions offset inward with respect to the right portion and the left portion of the joint portion 130. More specifically, the center in the width direction of the upper portion and the lower portion of the outer peripheral seal portion 140 is located outside the center in the width direction of the upper portion and the lower portion of the joint portion 130 (see FIG. 11(d)), and the center in the width direction of the right portion and the left portion of the outer peripheral seal portion 140 is located inside the center in the width direction of the right portion and the left portion of the joint portion 130 (see FIG. 10(d)).

The separators 100G and 100H as described above also have substantially the same effects as the separator 100 according to the first embodiment. Furthermore, according to the separators 100G and 100H as described above, an area of the portion (cooling portion Y) surrounded by the joint portion 130 overlapping with a part of the outer peripheral seal portion 140 can be made relatively large. Furthermore, an area of the portion (power generation portion X) surrounded by the other part of the outer peripheral seal portion 140 can be made relatively large, and the power generation efficiency of the fuel cell 1 can be improved.

As described above, the separators 100G and 100H according to the present embodiment include the seal portion (outer peripheral seal portion 140), in which
a first portion (one of an upper portion and a lower portion, and a right portion and a left portion) is formed at a position offset inward with respect to the joint portion 130 overlapping as viewed in the thickness direction, and
a second portion (the other of the upper part and the lower part, and the right part and the left part) different from the first portion is formed at a position offset outward with respect to the joint portion 130 overlapping as viewed in the thickness direction.

With such a configuration, it is possible to relatively increase an area of the portion (cooling portion Y) surrounded by the joint portion 130 overlapping the first portion (one of the upper portion and the lower portion, and the right portion and the left portion) of the seal portion (outer peripheral seal portion 140). Furthermore, an area of the portion (power generation portion X) surrounded by the second portion (the other of the upper part and the lower part, and the right part and the left part) of the seal portion (outer peripheral seal portion 140) can be made relatively large, and the power generation efficiency of the fuel cell 1 can be improved.

In a separator 100J according to a fifth embodiment of the present invention illustrated in FIGS. 12(c) and (d), an outer peripheral seal portion 140 formed on an anode separator 110 and an outer peripheral seal portion 140 formed on a cathode separator 120 are formed at positions offset from each other. Note that, in FIG. 12(d), the center in the width direction of the outer peripheral seal portion 140 formed on the anode separator 110 and the center in the width direction of the outer peripheral seal portion 140 formed on the cathode separator 120 are indicated by alternate long and short dash lines.

In the separator 100J, an example is illustrated in which the entire outer peripheral seal portion 140 formed on an anode side surface 110a of the anode separator 110 is formed at a position offset outward with respect to the outer peripheral seal portion 140 formed on a cathode side surface 120a of the cathode separator 120. More specifically, over the entire circumference of the outer peripheral seal portion 140 formed on the anode separator 110, the center of the outer peripheral seal portion 140 in the width direction is located outside the center of the outer peripheral seal portion 140 formed on the anode separator 110 in the width direction (see FIG. 12(d)).

Note that the example illustrated in FIG. 12 is an example, and the separator 100J according to the fifth embodiment is not limited to the above-described example. For example, the entire outer peripheral seal portion 140 formed on the anode separator 110 may be offset inward with respect to the outer peripheral seal portion 140 formed on the cathode separator 120. Furthermore, for example, at least a part in the extending direction of the outer peripheral seal portion 140 formed on the anode separator 110 may be located offset outward or inward with respect to the outer peripheral seal portion 140 formed on the cathode separator 120.

The separator 100J as described above also has substantially the same effect as the separator 100 according to the first embodiment. Furthermore, according to the separator 100J as described above, an area of the portion surrounded by one of the outer peripheral seal portion 140 formed on the anode separator 110 and the outer peripheral seal portion 140 formed on the cathode separator 120 can be made relatively large. As a result, for example, a balance of feed amounts of the fuel gas and the oxidation gas can be adjusted from the viewpoint of power generation efficiency.

As described above, in the separator 100J according to the present embodiment,
the seal portion (outer peripheral seal portion 140) is provided on both the fuel gas flow passage surface (anode side surface 110a) and the oxidation gas flow passage surface (cathode side surface 120a), and
the seal portion (outer peripheral seal portion 140) formed on the fuel gas flow passage surface (anode side surface 110a) and the seal portion (outer peripheral seal portion 140) formed on the oxidation gas flow passage surface (cathode side surface 120a) are formed at positions offset from each other.

With such a configuration, an area of the portion surrounded by one of the seal portion (outer peripheral seal portion 140) formed on the anode separator 110 and the seal portion (outer peripheral seal portion 140) formed on the cathode separator 120 can be made relatively large.

Note that, in each of the above embodiments, an example in which all of one sides constituting the upper portion, the lower portion, the left portion, and the right portion of the outer peripheral seal portion 140 are offset has been described, but the present invention is not limited to such an aspect. For example, only a part of the one side may be offset.

Furthermore, in each of the above embodiments, the anode separator 110 and the cathode separator 120 are joined by welding, but the present disclosure is not limited to such an aspect. As a method of joining the anode separator 110 and the cathode separator 120, for example, an appropriate joining method such as caulking or pressure bonding can be adopted.

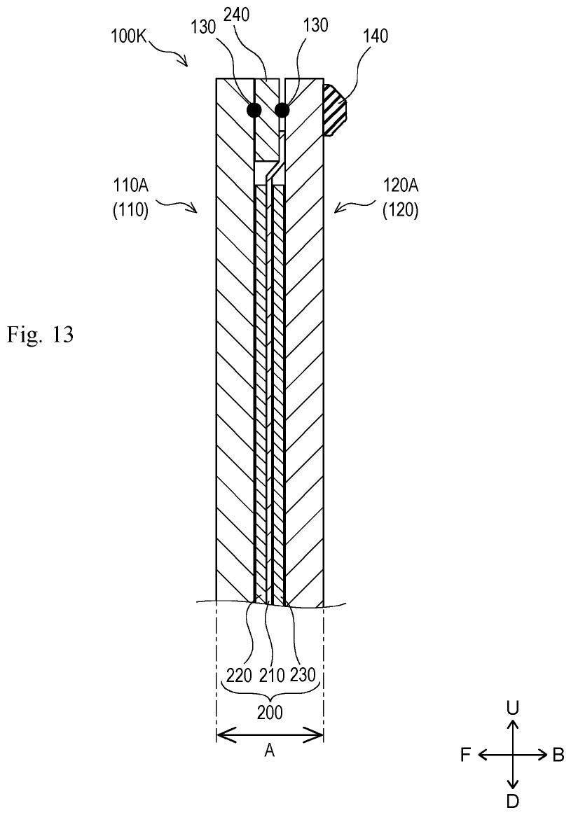

Furthermore, in the present embodiment, as illustrated in FIG. 7, an example is illustrated in which the separator 100 formed by joining the anode separator 110 and the cathode separator 120 to each other is adjacent to the membrane electrode assembly 200, but the present disclosure is not limited to such an aspect. For example, a sixth embodiment illustrated in FIG. 13 may be adopted.

A separator 100K according to the sixth embodiment of the present invention illustrated in FIG. 13 is different from each of the above-described embodiments in that an anode separator 110, a cathode separator 120, and a membrane electrode assembly 200 constituting a single cell A are integrally formed. The separator 100K is formed by joining both surfaces of a sheet portion 240 of the membrane electrode assembly 200 and outer peripheral portions of the anode separator 110 and the cathode separator 120 facing the sheet portion 240. In the present embodiment, the anode separator 110, the cathode separator 120, and the membrane electrode assembly 200 are joined by thermocompression bonding. A joint portion 130 is formed on an outer peripheral portion of the separator 100K by the thermocompression bonding.

Also in the present embodiment, the joint portion 130 and the outer peripheral seal portion 140 overlap each other as viewed in the thickness direction of the separator 100K. Note that, in the present embodiment, the outer peripheral seal portion 140 is provided only on one (the cathode separator 120) of the anode separator 110 and the cathode separator 120.

The separator 100K as described above also has substantially the same effect as the separator 100 according to the first embodiment.

Furthermore, in each of the above embodiments, an example in which the fuel cell 1 is used as a power supply for driving a motor or the like mounted on a vehicle has been described, but the present embodiments are not limited to such an aspect. For example, the fuel cell 1 may be used as a power supply of another electronic device mounted on the vehicle. Furthermore, the fuel cell 1 is not limited to the power supply for the vehicle, and can be used as a power supply for various electric products.

### INDUSTRIAL APPLICABILITY

The present invention can be applied to a separator constituting a fuel cell.

### REFERENCE SIGNS LIST

1: Fuel cell
100: Separator
110: Anode separator
120: Cathode separator
200: Membrane electrode assembly

1. A separator that is formed in a plate shape, constitutes a fuel cell, and is disposed so as to be adjacent to an electrolyte membrane to which fuel gas and oxidation gas are fed, the separator comprising:
an anode separator including a fuel gas flow passage surface on which a flow path of the fuel gas is formed;
a cathode separator including an oxidation gas flow passage surface on which a flow path of the oxidation gas is formed;
a joint portion that extends so as to surround the flow path of the fuel gas and the flow path of the oxidation gas, and joins the anode separator and the cathode separator to each other; and
a seal portion provided on at least one of the fuel gas flow passage surface and the oxidation gas flow passage surface, extending along the joint portion, and formed so as to overlap the joint portion when viewed in a thickness direction of the separator.

2. The separator according to claim 1, wherein
the seal portion is formed over an entire circumference of the joint portion.

3. The separator according to claim 1, wherein
at least a part of the seal portion is formed at a position offset inward with respect to the joint portion overlapping as viewed in the thickness direction.

4. The separator according to claim 1, wherein
at least a part of the seal portion is formed at a position offset outward with respect to the joint portion overlapping as viewed in the thickness direction.

5. The separator according to claim 1, wherein
the seal portion includes
a first portion formed at a position offset inward with respect to the joint portion overlapping as viewed in the thickness direction, and
a second portion formed at a position offset outward with respect to the joint portion overlapping as viewed in the thickness direction, the second portion being different from the first portion.

6. The separator according to claim 1, wherein
the seal portion is provided on both the fuel gas flow passage surface and the oxidation gas flow passage surface, and
the seal portion formed on the fuel gas flow passage surface and the seal portion formed on the oxidation gas flow passage surface are formed at positions offset from each other.

7. The separator according to claim 2, wherein
at least a part of the seal portion is formed at a position offset inward with respect to the joint portion overlapping as viewed in the thickness direction.

8. The separator according to claim 2, wherein
at least a part of the seal portion is formed at a position offset outward with respect to the joint portion overlapping as viewed in the thickness direction.

9. The separator according to claim 2, wherein
the seal portion includes
a first portion formed at a position offset inward with respect to the joint portion overlapping as viewed in the thickness direction, and
a second portion formed at a position offset outward with respect to the joint portion overlapping as viewed in the thickness direction, the second portion being different from the first portion.

10. The separator according to claim 2, wherein
the seal portion is provided on both the fuel gas flow passage surface and the oxidation gas flow passage surface, and
the seal portion formed on the fuel gas flow passage surface and the seal portion formed on the oxidation gas flow passage surface are formed at positions offset from each other.

11. The separator according to claim 3, wherein
the seal portion is provided on both the fuel gas flow passage surface and the oxidation gas flow passage surface, and
the seal portion formed on the fuel gas flow passage surface and the seal portion formed on the oxidation gas flow passage surface are formed at positions offset from each other.

12. The separator according to claim 4, wherein
the seal portion is provided on both the fuel gas flow passage surface and the oxidation gas flow passage surface, and
the seal portion formed on the fuel gas flow passage surface and the seal portion formed on the oxidation gas flow passage surface are formed at positions offset from each other.

13. The separator according to claim 5, wherein
the seal portion is provided on both the fuel gas flow passage surface and the oxidation gas flow passage surface, and
the seal portion formed on the fuel gas flow passage surface and the seal portion formed on the oxidation gas flow passage surface are formed at positions offset from each other.

14. The separator according to claim 7, wherein
the seal portion is provided on both the fuel gas flow passage surface and the oxidation gas flow passage surface, and
the seal portion formed on the fuel gas flow passage surface and the seal portion formed on the oxidation gas flow passage surface are formed at positions offset from each other.

15. The separator according to claim 8, wherein
the seal portion is provided on both the fuel gas flow passage surface and the oxidation gas flow passage surface, and
the seal portion formed on the fuel gas flow passage surface and the seal portion formed on the oxidation gas flow passage surface are formed at positions offset from each other.

16. The separator according to claim 9, wherein
the seal portion is provided on both the fuel gas flow passage surface and the oxidation gas flow passage surface, and
the seal portion formed on the fuel gas flow passage surface and the seal portion formed on the oxidation gas flow passage surface are formed at positions offset from each other.
